(19) United States
(12) Patent Application Publication
(10) Pub. No.: US 2013/0304739 A1
(43) Pub. Date: Nov. 14, 2013

(54) COMPUTING SYSTEM WITH DOMAIN INDEPENDENCE ORIENTATION MECHANISM AND METHOD OF OPERATION THEREOF

(71) Applicant: SAMSUNG ELECTRONICS CO., LTD., Gyeonggi-Do (KR)

(72) Inventors: Justin Martineau, San Jose, CA (US); Doreen Cheng, San Jose, CA (US)

(73) Assignee: Samsung Electronics Co., Ltd., Gyeonggi-Do (KR)

(21) Appl. No.: 13/890,541

(22) Filed: May 9, 2013

Related U.S. Application Data
(60) Provisional application No. 61/645,550, filed on May 10, 2012.
(60) Provisional application No. 61/676,279, filed on Jul. 26, 2012.
(60) Provisional application No. 61/791,088, filed on Mar. 15, 2013.

(51) Int. Cl. G06F 17/30

(52) U.S. Cl. CPC G06F 17/30705
USPC 707/737

(57) ABSTRACT

A computing system includes: a gather module configured to gather a distribution of a class bias score for a feature and across multiple domains; a transformation module, coupled to the gather module, configured to generate a transformation for a characteristic of a domain independence based on the class bias score; and a consolidation module, coupled to the transformation module, configured to compute a domain-independent class-bias score based on the transformation.

### CROSS-REFERENCE TO RELATED APPLICATION

This application claims the benefit of U.S. Provisional Patent Application Ser. No. 61/645,550 filed May 10, 2012, and the subject matter thereof is incorporated herein by reference thereto.

This application claims the benefit of U.S. Provisional Patent Application Ser. No. 61/676,279 filed Jul. 26, 2012, and the subject matter thereof is incorporated herein by reference thereto.

This application claims the benefit of U.S. Provisional Patent Application Ser. No. 61/791,088 filed Mar. 15, 2013, and the subject matter thereof is incorporated herein by reference thereto.

### TECHNICAL FIELD

An embodiment of the present invention relates generally to a computing system, and more particularly to a system for domain independence orientation.

### BACKGROUND

Modern consumer and industrial electronics, such as computing systems, televisions, projectors, cellular phones, portable digital assistants, and combination devices, are providing increasing levels of functionality to support modern life. In addition to the explosion of functionality and proliferation of these devices into the everyday life, there is also an explosion of data and information being created, transported, consumed, and stored.

The explosion of data and information comes in different types, e.g. text, sounds, images, as well as for different domains/applications, e.g. social networks, electronic mail, web searches, and different formats, e.g. structure, unstructured, or semi-structured. Research and development for handling this dynamic mass of data and information in existing technologies can take a myriad of different directions.

Thus, a need still remains for a computing system with domain independence orientation mechanism for effectively addressing the mass of data and information across various domains. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a computing system, including: a gather module configured to gather a distribution of a class bias score for a feature and across multiple domains; a transformation module, coupled to the gather module, configured to generate a transformation for a characteristic of a domain independence based on the class bias score; and a consolidation module, coupled to the transformation module, configured to compute a domain-independent class-bias score based on the transformation.

An embodiment of the present invention provides a method of operation of a computing system including: gathering a distribution of a class bias score for a feature and across multiple domains through a communication unit; generating a transformation for a characteristic of a domain independence based on the class bias score; and computing a domain-independent class-bias score based on the transformation.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a computing system with domain independence orientation mechanism in an embodiment of the present invention.

FIG. 2 is an exemplary block diagram of the computing system.

FIG. 3 is a control flow of the computing system.

FIG. 4 is the control flow with examples of some of the features operated by the computing system.

FIG. 5 is the control flow with examples of the transformations of the computing system.

FIG. 6 is a graphical view of the performance improvement with the computing system.

FIG. 7 is an architecture view of an exemplary application for a model synthesis with the computing system.

FIG. 8 is a flow chart of a method of operation of a computing system in a further embodiment of the present invention.

### DETAILED DESCRIPTION

An embodiment of the present invention provides a method and system configured to generate domain-independent models by learning general purpose score for features, such as words/phrases, including those with conflicting orientations in multiple domains with different topic areas, those with a neutral orientation in one or more topic areas, and those with unknown orientation in one or more topic areas. The embodiment of the present invention also measures reliability of the features, e.g. word/phrase, over multiple domains and increases/decreases the domain-independent class-bias score or the final score magnitude accordingly. The embodiment of the present invention also measures broad applicability (how likely is it to be useful later) of word/phrase and increases final score magnitude accordingly. The embodiment of the present invention also is scalable—additional topic areas increase vocabulary size.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

The term “module” referred to herein can include software, hardware, or a combination thereof in the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

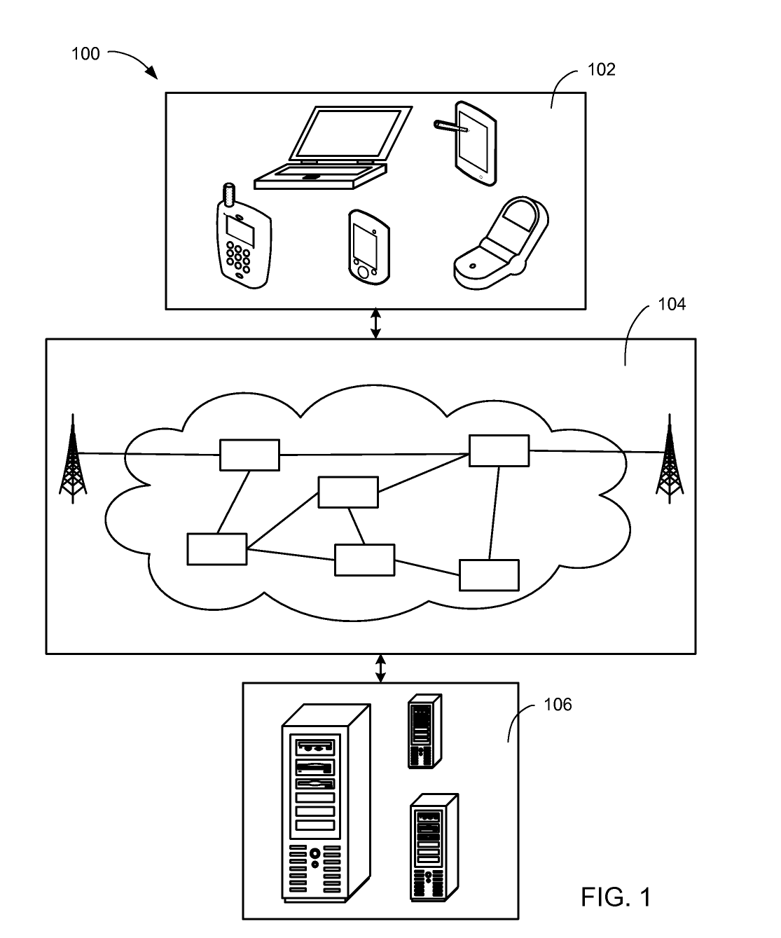

Referring now to FIG. 1, therein is shown a computing system 100 with domain independence orientation mechanism in an embodiment of the present invention. The computing system 100 includes a first device 102, such as a client or a server, connected to a second device 106, such as a client or server. The first device 102 can communicate with the second device 106 with a communication path 104, such as a wireless or wired network.

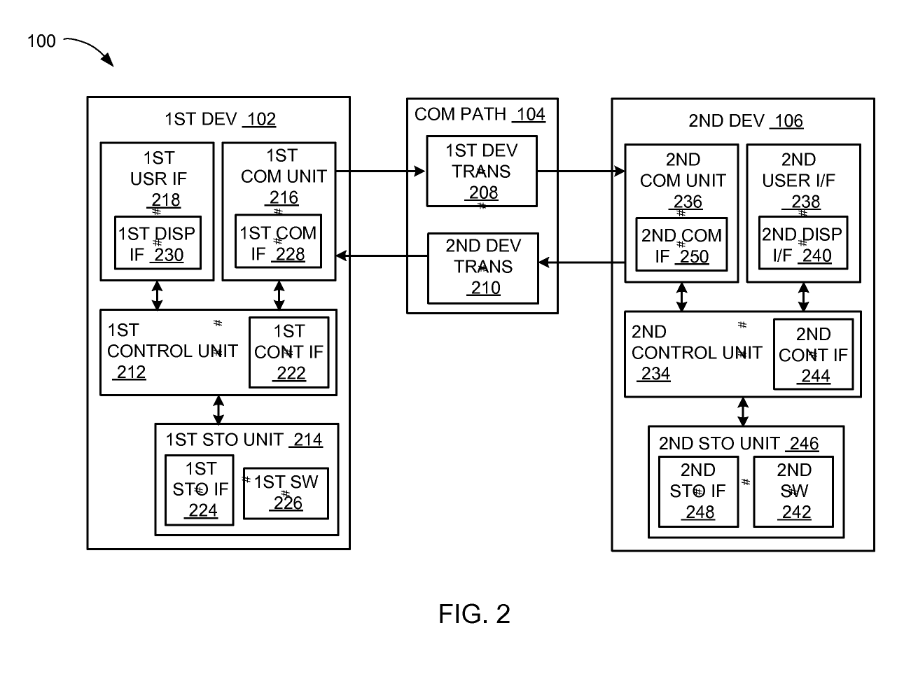

Users of the first device 102, the second device 106, or a combination thereof can communicate with each other or access or create information including text, images, symbols, location information, and audio, as examples. The users can be individuals or enterprise companies. The information can be created directly from a user or operations performed on these information to create more or different information. The communication involving can take more different forms, as described more in FIG. 2.

In the connected world, information creation, transmission, and storage are pervasive as well as the desire to consume all these information by the users. However, the shear mass of information makes it impossible to effectively and efficiency consume or deliver the right information and the right time.

Returning to the description of the computing system 100, the first device 102 can be of any of a variety of devices, such as a smartphone, a cellular phone, personal digital assistant, a tablet computer, a notebook computer, or other multi-functional display or entertainment device. The first device 102 can couple, either directly or indirectly, to the communication path 104 to communicate with the second device 106 or can be a stand-alone device.

For illustrative purposes, the computing system 100 is described with the first device 102 as a display device, although it is understood that the first device 102 can be different types of devices. For example, the first device 102 can also be a device for presenting images or a multi-media presentation. A multi-media presentation can be a presentation including sound, a sequence of streaming images or a video feed, text or a combination thereof.

The second device 106 can be any of a variety of centralized or decentralized computing devices, or transmission devices. For example, the second device 106 can be a a laptop computer, a desktop computer, a video game console, grid-computing resources, a virtualized computer resource, cloud computing resource, routers, switches, peer-to-peer distributed computing devices, or a combination thereof. In another example, the second device 106 can be a signal receiver for receiving broadcast or live stream signals, such as a television receiver, a cable box, a satellite dish receiver, or a web enabled device.

The second device 106 can be centralized in a single room, distributed across different rooms, distributed across different geographical locations, embedded within a telecommunications network. The second device 106 can couple with the communication path 104 to communicate with the first device 102.

For illustrative purposes, the computing system 100 is described with the second device 106 as a computing device, although it is understood that the second device 106 can be different types of devices. Also for illustrative purposes, the computing system 100 is shown with the second device 106 and the first device 102 as end points of the communication path 104, although it is understood that the computing system 100 can have a different partition between the first device 102, the second device 106, and the communication path 104. For example, the first device 102, the second device 106, or a combination thereof can also function as part of the communication path 104.

The communication path 104 can span and represent a variety of network types and network topologies. For example, the communication path 104 can include wireless communication, wired communication, optical, ultrasonic, or the combination thereof. Satellite communication, cellular communication, Bluetooth, Infrared Data Association standard (lrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104. Further, the communication path 104 can traverse a number of network topologies and distances. For example, the communication path 104 can include direct connection, personal area network (PAN), local area network (LAN), metropolitan area network (MAN), wide area network (WAN), or a combination thereof.

Referring now to FIG. 2, therein is shown an exemplary block diagram of the computing system 100. The computing system 100 can include the first device 102, the communication path 104, and the second device 106. The first device 102 can send information in a first device transmission 208 over the communication path 104 to the second device 106. The second device 106 can send information in a second device transmission 210 over the communication path 104 to the first device 102.

For illustrative purposes, the computing system 100 is shown with the first device 102 as a client device, although it is understood that the computing system 100 can have the first device 102 as a different type of device. For example, the first device 102 can be a server having a display interface.

Also for illustrative purposes, the computing system 100 is shown with the second device 106 as a server, although it is understood that the computing system 100 can have the second device 106 as a different type of device. For example, the second device 106 can be a client device.

For brevity of description in this embodiment of the present invention, the first device 102 will be described as a client device and the second device 106 will be described as a server device. The present invention is not limited to this selection for the type of devices. The selection is an example of the present invention.

The first device 102 can include a first control unit 212, a first storage unit 214, a first communication unit 216, and a first user interface 218. The first control unit 212 can include a first control interface 222. The first control unit 212 can execute a first software 226 to provide the intelligence of the computing system 100.

The first control unit 212 can be implemented in a number of different manners. For example, the first control unit 212 can be a processor, an application specific integrated circuit (ASIC) an embedded processor, a microprocessor, a hardware control logic, a hardware finite state machine (FSM), a digital signal processor (DSP), or a combination thereof. The first control interface 222 can be used for communication between the first control unit 212 and other functional units in the first device 102. The first control interface 222 can also be used for communication that is external to the first device 102.

The first control interface 222 can receive information from the other functional units or from external sources, or can transmit information to the other functional units or to external destinations. The external sources and the external destinations refer to sources and destinations external to the first device 102.

The first control interface 222 can be implemented in different ways and can include different implementations depending on which functional units or external units are being interfaced with the first control interface 222. For example, the first control interface 222 can be implemented with a pressure sensor, an inertial sensor, a microelectromechanical system (MEMS), optical circuitry, waveguides, wireless circuitry, wireline circuitry, or a combination thereof.

A first storage unit 214 can store the first software 226. The first storage unit 214 can also store the relevant information, such as data representing incoming images, data representing previously presented image, sound files, or a combination thereof.

The first storage unit 214 can be a volatile memory, a nonvolatile memory, an internal memory, an external memory, or a combination thereof. For example, the first storage unit 214 can be a nonvolatile storage such as non-volatile random access memory (NVRAM), Flash memory, disk storage, or a volatile storage such as static random access memory (SRAM).

The first storage unit 214 can include a first storage interface 224. The first storage interface 224 can be used for communication between and other functional units in the first device 102. The first storage interface 224 can also be used for communication that is external to the first device 102.

The first storage interface 224 can receive information from the other functional units or from external sources, or can transmit information to the other functional units or to external destinations. The external sources and the external destinations refer to sources and destinations external to the first device 102.

The first storage interface 224 can include different implementations depending on which functional units or external units are being interfaced with the first storage unit 214. The first storage interface 224 can be implemented with technologies and techniques similar to the implementation of the first control interface 222.

A first communication unit 216 can enable external communication to and from the first device 102. For example, the first communication unit 216 can permit the first device 102 to communicate with the second device 106 of FIG. 1, an attachment, such as a peripheral device or a computer desktop, and the communication path 104.

The first communication unit 216 can also function as a communication hub allowing the first device 102 to function as part of the communication path 104 and not limited to be an end point or terminal unit to the communication path 104. The first communication unit 216 can include active and passive components, such as microelectronics or an antenna, for interaction with the communication path 104.

The first communication unit 216 can include a first communication interface 228. The first communication interface 228 can be used for communication between the first communication unit 216 and other functional units in the first device 102. The first communication interface 228 can receive information from the other functional units or can transmit information to the other functional units.

The first communication interface 228 can include different implementations depending on which functional units are being interfaced with the first communication unit 216. The first communication interface 228 can be implemented with technologies and techniques similar to the implementation of the first control interface 222.

The first user interface 218 allows a user (not shown) to interface and interact with the first device 102. The first user interface 218 can include an input device and an output device. Examples of the input device of the first user interface 218 can include a keypad, a touchpad, soft-keys, a keyboard, a microphone, an infrared sensor for receiving remote signals, or any combination thereof to provide data and communication inputs.

The first user interface 218 can include a first display interface 230. The first display interface 230 can include a display, a projector, a video screen, a speaker, or any combination thereof.

The first control unit 212 can operate the first user interface 218 to display information generated by the computing system 100. The first control unit 212 can also execute the first software 226 for the other functions of the computing system 100. The first control unit 212 can further execute the first software 226 for interaction with the communication path 104 via the first communication unit 216.

The second device 106 can be optimized for implementing the present invention in a multiple device embodiment with the first device 102. The second device 106 can provide the additional or higher performance processing power compared to the first device 102. The second device 106 can include a second control unit 234, a second communication unit 236, and a second user interface 238.

The second user interface 238 allows a user (not shown) to interface and interact with the second device 106. The second user interface 238 can include an input device and an output device. Examples of the input device of the second user interface 238 can include a keypad, a touchpad, soft-keys, a keyboard, a microphone, or any combination thereof to provide data and communication inputs. Examples of the output device of the second user interface 238 can include a second display interface 240. The second display interface 240 can include a display, a projector, a video screen, a speaker, or any combination thereof.

The second control unit 234 can execute a second software 242 to provide the intelligence of the second device 106 of the computing system 100. The second software 242 can operate in conjunction with the first software 226. The second control unit 234 can provide additional performance compared to the first control unit 212.

The second control unit 234 can operate the second user interface 238 to display information. The second control unit 234 can also execute the second software 242 for the other functions of the computing system 100, including operating the second communication unit 236 to communicate with the first device 102 over the communication path 104.

The second control unit 234 can be implemented in a number of different manners. For example, the second control unit 234 can be a processor, an embedded processor, a microprocessor, hardware control logic, a hardware finite state machine (FSM), a digital signal processor (DSP), or a combination thereof.

The second control unit 234 can include a second controller interface 244. The second controller interface 244 can be used for communication between the second control unit 234 and other functional units in the second device 106. The second controller interface 244 can also be used for communication that is external to the second device 106.

The second controller interface 244 can receive information from the other functional units or from external sources, or can transmit information to the other functional units or to external destinations. The external sources and the external destinations refer to sources and destinations external to the second device 106.

The second controller interface 244 can be implemented in different ways and can include different implementations depending on which functional units or external units are being interfaced with the second controller interface 244. For example, the second controller interface 244 can be implemented with a pressure sensor, an inertial sensor, a microelectromechanical system (MEMS), optical circuitry, waveguides, wireless circuitry, wireline circuitry, or a combination thereof.

A second storage unit 246 can store the second software 242. The second storage unit 246 can also store the such as data representing incoming images, data representing previously presented image, sound files, or a combination thereof. The second storage unit 246 can be sized to provide the additional storage capacity to supplement the first storage unit 214.

For illustrative purposes, the second storage unit 246 is shown as a single element, although it is understood that the second storage unit 246 can be a distribution of storage elements. Also for illustrative purposes, the computing system 100 is shown with the second storage unit 246 as a single hierarchy storage system, although it is understood that the computing system 100 can have the second storage unit 246 in a different configuration. For example, the second storage unit 246 can be formed with different storage technologies forming a memory hierarchal system including different levels of caching, main memory, rotating media, or off-line storage.

The second storage unit 246 can be a volatile memory, a nonvolatile memory, an internal memory, an external memory, or a combination thereof. For example, the second storage unit 246 can be a nonvolatile storage such as non-volatile random access memory (NVRAM), Flash memory, disk storage, or a volatile storage such as static random access memory (SRAM).

The second storage unit 246 can include a second storage interface 248. The second storage interface 248 can be used for communication between other functional units in the second device 106. The second storage interface 248 can also be used for communication that is external to the second device 106.

The second storage interface 248 can receive information from the other functional units or from external sources, or can transmit information to the other functional units or to external destinations. The external sources and the external destinations refer to sources and destinations external to the second device 106.

The second storage interface 248 can include different implementations depending on which functional units or external units are being interfaced with the second storage unit 246. The second storage interface 248 can be implemented with technologies and techniques similar to the implementation of the second controller interface 244.

The second communication unit 236 can enable external communication to and from the second device 106. For example, the second communication unit 236 can permit the second device 106 to communicate with the first device 102 over the communication path 104.

The second communication unit 236 can also function as a communication hub allowing the second device 106 to function as part of the communication path 104 and not limited to be an end point or terminal unit to the communication path 104. The second communication unit 236 can include active and passive components, such as microelectronics or an antenna, for interaction with the communication path 104.

The second communication unit 236 can include a second communication interface 250. The second communication interface 250 can be used for communication between the second communication unit 236 and other functional units in the second device 106. The second communication interface 250 can receive information from the other functional units or can transmit information to the other functional units.

The second communication interface 250 can include different implementations depending on which functional units are being interfaced with the second communication unit 236. The second communication interface 250 can be implemented with technologies and techniques similar to the implementation of the second controller interface 244.

The first communication unit 216 can couple with the communication path 104 to send information to the second device 106 in the first device transmission 208. The second device 106 can receive information in the second communication unit 236 from the first device transmission 208 of the communication path 104.

The second communication unit 236 can couple with the communication path 104 to send information to the first device 102 in the second device transmission 210. The first device 102 can receive information in the first communication unit 216 from the second device transmission 210 of the communication path 104. The computing system 100 can be executed by the first control unit 212, the second control unit 234, or a combination thereof. For illustrative purposes, the second device 106 is shown with the partition having the second user interface 238, the second storage unit 246, the second control unit 234, and the second communication unit 236, although it is understood that the second device 106 can have a different partition. For example, the second software 242 can be partitioned differently such that some or all of its function can be in the second control unit 234 and the second communication unit 236. Also, the second device 106 can include other functional units not shown in FIG. 2 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the computing system 100 is described by operation of the first device 102 and the second device 106. It is understood that the first device 102 and the second device 106 can operate any of the modules and functions of the computing system 100.

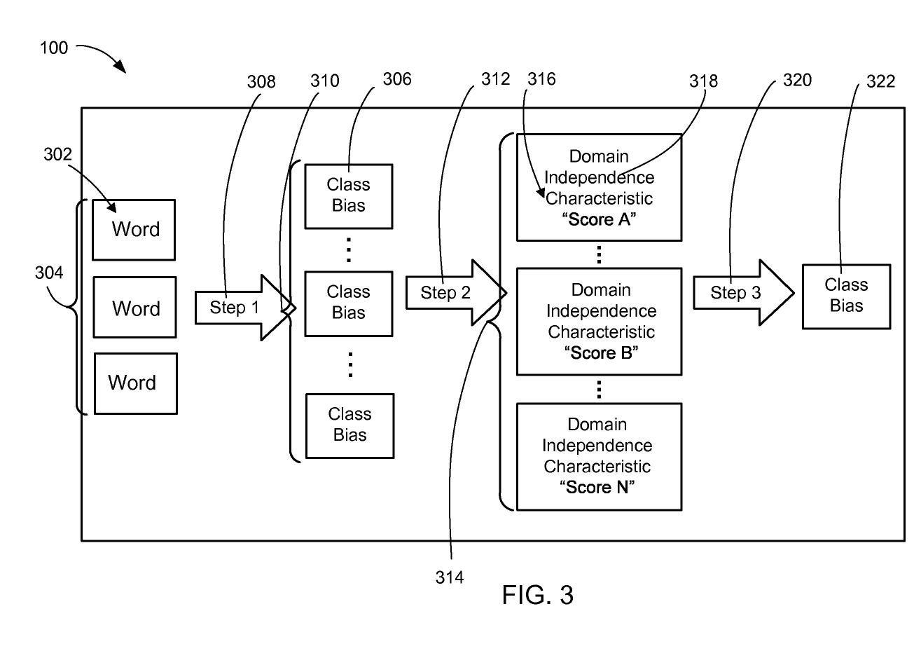

Referring now to FIG. 3, therein is shown a control flow of the computing system 100. FIG. 3, as an example, depicts features 302 from multiple domains 304. Class bias scores 306 can be computed for each of the features 302 for a domain from the multiple domains 304.

The features 302 is an attribute from an item being analyzed. For example, the features 302 can represent a word, a phrase, an n-gram of words, or a bag of characters for a document or item being analyzed. The multiple domains 304 are topic areas where each domain can represent a different topic area from the other domains. The class bias scores 306 are orientation scores for each of the features 302 for each of the domains in the multiple domains 304.

As an example, the computing system 100 include a gather module 308, depicted as “Step 1” in FIG. 3, to gather a distribution 310 of the class bias scores 306 across the multiple domains 304 for each of the features 302. The gather module 308 can operate through the first communication unit 216 of FIG. 2 or the second communication unit 236 of FIG. 2. The gather module 308 can provide the class bias scores 306 for each of the features 302 to a transformation module 312, depicted as “Step 2” in FIG. 3. The details of the gather module 308 will be discussed later.

The transformation module 312 generates transformations 314 based on the class bias scores 306 from the multiple domains 304. Each of the transformations 314 is a score for a characteristic 316 for each of the features 302 to be applied for domain independence. The characteristic 316 is an attribute for each of the features 302 to be used in a context of a domain independence 318. The domain independence 318 refers to applicability to different topics or the multiple domains 304 without being constrained to a specific topic area. The details of the transformation module 312 will be discussed later.

The transformation module 312 can provide the transformations 314 to a consolidation module 320, depicted as “Step 3” in FIG. 3. The consolidation module 320 combines the transformations 314 for each of the features 302 to compute a domain-independent class-bias score 322 for each of the features 302. The domain-independent class-bias score 322 determines how to meaningfully combine the transformations 314 to measure the domain independent orientation of each of the features 302 to the category. The details about the consolidation module 320 will be discussed later.

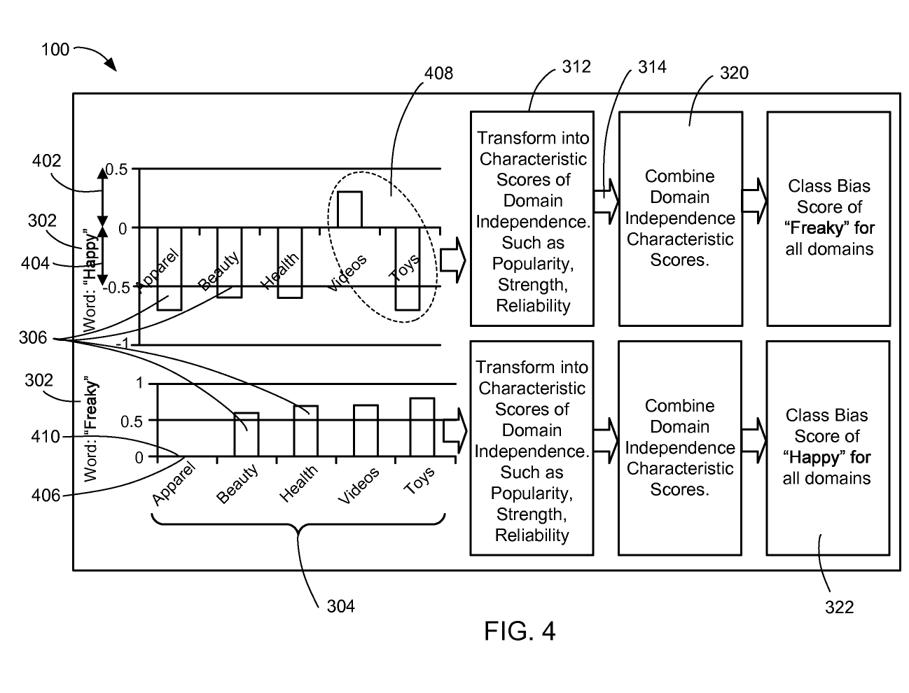

Referring now to FIG. 4, therein is shown the control flow with examples of some of the features 302 operated by the computing system 100. This figure depicts, as examples, two words as the features 302 being processed by the control flow. The first example is for a word “Freaky” as one of the features 302. The second example is for a word “Happy” as one of the features 302.

For the first example, the class bias scores 306 are shown for the multiple domains 304 of “Apparel”, “Beauty”, “Health”, “Videos”, and “Toys”. Each of the domain in the multiple domains 304 represent a different topic area relative to the other. The values for the class bias scores 306 are along an x-axis and each of the class bias scores 306 for each of the multiple domains 304 are shown as a bar.

The class bias scores 306 above the “0” value of the x-axis is deemed to be a positive orientation 402 for the feature or word for that particular instance from the multiple domains 304. The class bias scores 306 below the “0” value of the x-axis is deemed to be a negative orientation 404 for the feature or word for that particular instance from the multiple domains 304. The class bias scores 306 with the “0” value of the x-axis is deemed to be a neutral orientation 410 for the features 302 or word for that particular instance from the multiple domains 304.

In the first example, the class bias scores 306 for the word “Happy” has the positive orientation 402 for the Video domain and the negative orientation 404 in the rest of the multiple domains 304 depicted. The word “Happy” or one of the features 302 in this example has a conflicting orientation 408 across the multiple domains 304. The conflicting orientation 408 is when one of the features 302 has at least one domain that has an orientation opposite, such as positive or negative, from another domain across the multiple domains 304.

In the second example, one of the features is shown as “Freaky”. Across most of the multiple domains 304, the class bias scores 306 is in the positive orientation 402. However, for this example, the domain of “Apparel” does not have a score for “Freaky” and perhaps indicating an unknown orientation 406. The unknown orientation 406 is when the class bias scores 306 is not provided for that particular feature for that particular domain. The unknown orientation 406 can arise from the feature not appearing in the document or item being analyzed for that particular domain. This example can also be an example of the neutral orientation 410 for the “Apparel” domain.

The first example and the second example represent a graphical depiction of the class bias scores 306 gathered by the gather module 308 of FIG. 3. The gather module 308, as described earlier, can provide the class bias scores 306 for the features 302 across the multiple domains 304 to the transformation module 312. The gather module 308 can also provide the orientations to the transformation module 312. The orientations can include the positive orientation 402, the negative orientation 404, the conflicting orientation 408, the unknown orientation 406, and the neutral orientation 410, as examples.

The transformation module 312 can generate the transformations 314 for each of the features 302 of “Freaky” and “Happy”, in this example, to the consolidation module 320. The consolidation module 320 generate the domain-independent class-bias score 322 for “Freaky” and “Happy” separately. The consolidation module 320 can compute the domain-independent class-bias score 322 based on the conflicting orientation 408, the unknown orientation 406, and the neutral orientation 410.

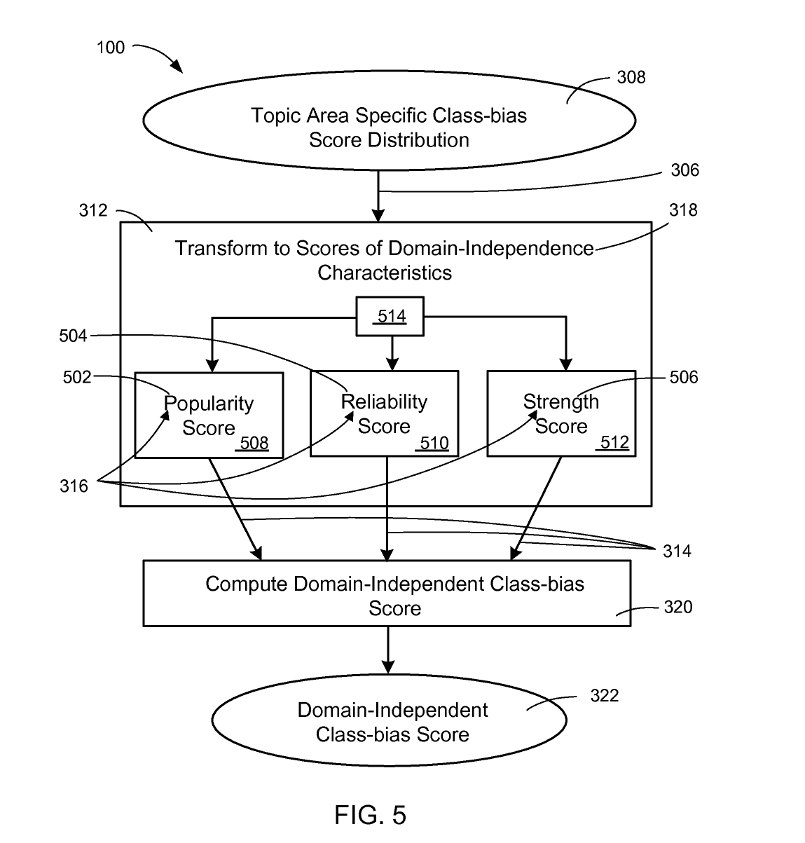

Referring now to FIG. 5, therein is shown the control flow with examples of the transformations 314 of the computing system 100. FIG. 5 depicts the gather module 308 gather the class bias scores 306 from the multiple domains 304 of FIG. 3 and providing the class bias scores 306 to the transformation module 312. As discussed earlier, the transformation module 312 provides the transformations 314 to the consolidation module 320 to generate the domain-independent class-bias score 322 for each of the features 302 of FIG. 4.

FIG. 5 provides additional details about the transformation module 312 and the characteristic 316 for each of the features 302 for the domain independence 318. In this example, the characteristic 316 include a popularity 502, a reliability 504, and a strength 506 for each of the features 302 in the context of domain independence 318. The popularity 502, the reliability 504, and the strength 506 are conveyed by the transformations 314 of a popularity score 508, a reliability score 510, and a strength score 512, respectively.

The popularity score 508 provides a measure of how often a selection of the features 302 is oriented to a class or category. In the examples from FIG. 4, the popularity score 508 provides a measure of how often the word “Freaky” or “Happy”, separately, is oriented to the positive orientation 402 of FIG. 4, the negative orientation 404 of FIG. 4, the neutral orientation 410 of FIG. 4, the unknown orientation 406 of FIG. 4, or a combination thereof. The reliability score 510 provides a measure of how reliable or stable the orientation is to a class over the multiple domains 304. The strength score 512 provides a measure of how strongly oriented the selection of the features 302 is to the class. The domain-independent class-bias score 322 determines how to meaningfully combine the popularity score 508, the reliability score 510, and the strength score 512 to measure the domain independent orientation of the word, phrase, or other item to the category.

The transformations 314, the popularity score 508, the reliability score 510, and the strength score 512 as well as the domain-independent class-bias score 322 can be computed based on only selecting one of the orientation of the positive orientation 402 or the negative orientation 404. The transformations 314, the popularity score 508, the reliability score 510, and the strength score 512 as well as the domain-independent class-bias score 322 can also be computed based on both the positive orientation 402 and the negative orientation 404.

The reliability score 510, the strength score 512, or a combination thereof can be calculated using a weighting scheme 514 for the class bias scores 306 for each of the features 302. As an example of the weighting scheme 514 for the reliability score 510, the strength score 512, or a combination thereof is a delta inverse document frequency (ΔIDF). The popularity score 508 can be also calculated using the weighting scheme 514 for the class bias scores 306 for each of the features 302.

As an example, the class bias scores 306 from the gather module 308 can be the set of orientation scores produce by ΔIDF for each of the “d” domains or the multiple domains 304, in other words topic areas. The domain-independent class-bias score 322 or the domain independent orientation scores to the positive and negative sentiment categories, or the positive orientation 402 and the negative orientation 404, respectively, can be computed for each of the features 302 or for each term, such as a word in FIG. 3, “t” after sorting the ΔIDF scores for the term into two sets, the set of “P” positive scores (in the positive orientation 402) and the set of “N” negative scores (in the negative orientation 404) ΔIDF scores that are greater than zero are oriented to the positive sentiment category, as described in FIG. 4, while those that are less than zero are oriented to the negative sentiment category, also as described in FIG. 4.

One example for the transformations 314 with only the negative orientation 404 is described. The popularity score 508, the reliability score 510, and the strength score 512 will be described based on the negative orientation 404 of the class bias scores 306 across the multiple domains 304.

The popularity score 508 can be implemented by counting the number of orientation scores that are orientated to the category. For the “Freaky” example, the popularity score 508 with the negative orientation 404 is 4 while the popularity score 508 with the positive orientation 402 is 1.

The popularity score 508 for a term “t” or one of the features 302 for the negative orientation 404 is shown in Equation 1.

Popularity(t)=N (Equation 1)

“N” is the number the domains in the multiple domains 304 where “t” is oriented to the negative class or with the negative orientation 404.

As an example, the reliability score 510 can be implemented with a geometric mean of the absolute value of the orientation scores to the category. For the example using the negative orientation 404, the reliability score 510 for the term “t”, or one of the features 302, to the negative sentiment category orientation scores, or the negative orientation 404, using Equation 2.

Reliability(t)=^{N}\sqrt{|π_{d}^{N}ΔIDF_{d}(t)|} (Equation 2)

The term “d” is an ordinal number, which specifies the specific domain from the multiple domains 304 of FIG. 3. The term “d” provides an index into the set of the class bias scores 306 for the specific domain being calculated.

As an example, the strength score 512 can be implemented with an arithmetic mean of the orientation scores to that category. For the example using the negative orientation 404, the strength score 512 is shown in Equation 3.

$$Strength ( t ) = \frac{1}{N} {\sum }_{d}^{N} Δ {IDF}_{d} ( t ) \qquad ( Equation 3 )$$

Continuing with the example for the transformations 314 with the popularity score 508, the reliability score 510, and the strength score 512, the consolidation module 320 can generate the domain-independent class-bias score 322. The domain-independent class-bias score 322 can be implemented by multiplying the popularity score 508, the reliability score 510, and the strength score 512 described by Equation 1, Equation 2, and Equation 3, respectively, so terms that are strong, reliable, and popular get a final score that is greater than the sum of their parts. For example, the domain independent orientation score, the domain-independent class-bias score 322, for the term “t” to the negative sentiment category, the negative orientation 404, can be calculated as a function of the set of “N” negative sentiment category orientation scores using Equation 4.

$$\begin{matrix}DIO ( t ) = Popularity ( t ) Reliability ( t ) Strength ( t ) \\ = N \frac{1}{N} {\sum }_{d}^{N} Δ {IDF}_{d} ( t ) \sqrt[N]{\vert {\prod }_{d}^{N} Δ {IDF}_{d} ( t ) \vert} \\ = {\sum }_{d}^{N} Δ {IDF}_{d} ( t ) \sqrt[N]{\vert {\prod }_{d}^{N} Δ {IDF}_{d} ( t ) \vert}\end{matrix} \qquad ( Equation 4 )$$

Another example for the transformations 314 with only the positive orientation 402 is described. The popularity score 508, the reliability score 510, and the strength score 512 will be described based on the positive orientation 402 of the class bias scores 306 across the multiple domains 304.

The popularity score 508 for a term “t” or one of the features 302 for the positive orientation 402 is shown in Equation 5.

Popularity(t)=P (Equation 5)

“P” is the number the domains in the multiple domains 304 where “t” is oriented to a class positive or with the positive orientation 402.

For the example using the positive orientation 402, the reliability score 510 for the term “t”, or one of the features 302, to the positive sentiment category orientation scores, or the positive orientation 402, using Equation 6.

$$\begin{matrix}D I O ( t ) = Popularity ( t ) Reliability ( t ) Strength ( t ) \\ = P \frac{1}{P} {\sum }_{d}^{P} Δ {IDF}_{d} ( t ) \sqrt[P]{{\prod }_{d}^{P} Δ {IDF}_{d} ( t )} \\ = {\sum }_{d}^{P} Δ {IDF}_{d} ( t ) \sqrt[P]{{\prod }_{d}^{P} Δ {IDF}_{d} ( t )}\end{matrix} \qquad ( Equation 8 )$$

For the example using the positive orientation 402, the strength score 512 is shown in Equation 7.

$$Strength ( t ) = \frac{1}{P} {\sum }_{d}^{P} Δ {IDF}_{d} ( t ) \qquad ( Equation 7 )$$

Continuing with the example for the transformations 314 with the popularity score 508, the reliability score 510, and the strength score 512, the consolidation module 320 can generate the domain-independent class-bias score 322 by multiplying the popularity score 508, the reliability score 510, and the strength score 512 described by Equation 5, Equation 6, and Equation 7, respectively, For example, the domain independent orientation score, the domain-independent class-bias score 322, for the term “t” to the positive sentiment category, the positive orientation 402, can be calculated as a function of the set of “P” positive sentiment category orientation scores using Equation 8.

$$\begin{matrix}DIO ( t ) = Popularity ( t ) Reliability ( t ) Strength ( t ) \\ = P \frac{1}{P} {\sum }_{d}^{P} Δ {IDF}_{d} ( t ) \sqrt[P]{{\prod }_{d}^{P} Δ {IDF}_{d} ( t )} \\ = {\sum }_{d}^{P} Δ {IDF}_{d} ( t ) \sqrt[P]{{\prod }_{d}^{P} Δ {IDF}_{d} ( t )}\end{matrix} \qquad ( Equation 8 )$$

As a further example, the domain independent orientation score, the domain-independent class-bias score 322, for the term “t” to the positive sentiment category, the positive orientation 402, can be calculated as a function of the set of “P” positive sentiment category orientation scores and to the negative sentiment category, the negative orientation 404, can be calculated as a function of the set of “N” negative sentiment category orientation scores using Equation 9.

$$\begin{matrix}DIO ( t ) = Popularity ( t ) Reliability ( t ) Strength ( t ) \\ = {\sum }_{d}^{P} Δ {IDF}_{d} ( t ) \sqrt[P]{{\prod }_{d}^{P} Δ {IDF}_{d} ( t )} - \\ \vert {\sum }_{d}^{N} Δ {IDF}_{d} ( t ) \sqrt[N]{\vert {\prod }_{d}^{N} Δ {IDF}_{d} ( t ) \vert} \vert\end{matrix} \qquad ( Equation 9 )$$

Equation 9 is shown as a linear combination of Equation 4 and Equation 8.

Equation 9 rewards strongly oriented domain independent sentiment terms. The equation does this by multiplying together the arithmetic sum with the geometric mean, for the set of positive ΔIDF values for the term “t” or one of the features 302. Equation 9 then subtracts from this value the same computation for the negative set of ΔIDF values. This balances the positive sentimental, the positive orientation 402, uses for the term against its negative, the negative orientation 404, uses to produce a meaningful sentimental orientation for the term across the entire dataset and across the multiple domains 304. As such, Equation 9 rewards terms that occur in more domains, terms with stronger overall bias, and terms with more uniform sentiment scores as these are important factors in sentimental domain independence.

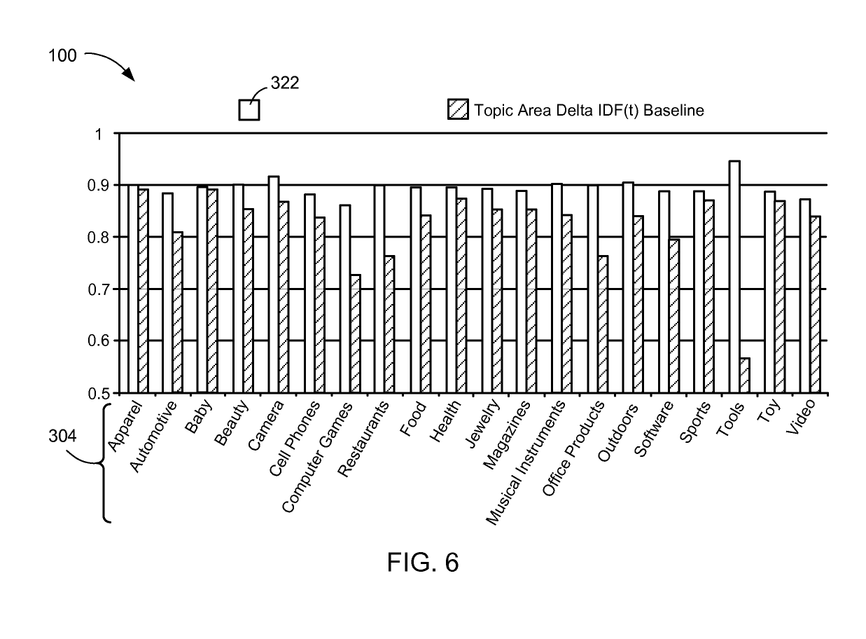

Referring now to FIG. 6, therein is shown a graphical view of the performance improvement with the computing system 100. As an example, Equation 9 can be used to build a domain-independent model using data from 5 domains as part of the multiple domains 304 of FIG. 3: books, DVDs, electronics, kitchen appliances, and music.

It has been discovered that classifiers based on the domain-independent class-bias score 322 computed with Equation 4, Equation 8, or Equation 9 and the transformations 314 of FIG. 3 substantially outperform in-domain baselines and domain adaption approaches. Performance improvements are shown to improve accuracy by over 7%.

To simulate a real world environment where data for most of the topic areas are not available, the training dataset is limited to the five most popular domains, books, DVDs, electronics, kitchen, and music. The other 20 domains were reserved as test data. Our experiments show that even with only a handful of domains we can train a highly accurate domain-independent model that outperforms current state-of-the-art results. Using the domain-independent class-bias score 322 and the transformations 314, we built a model from the books, DVDs, electronics, kitchen, and music domains. On average our domain independent model using the domain-independent class-bias score 322 is 89.6% accurate, which is a statistically significant improvement over the 82.3% accurate product area specific ΔIDF baselines to the 99.95% confidence interval.

FIG. 6 shows the accuracy of our classifier based on the domain-independent class-bias score 322 compared to the baseline for each of our 20 test product review categories. Over these test domains or the multiple domains 304, our domain independent model based on the domain-independent class-bias score 322 is always more accurate than the in-domain model.

The product specific baselines built using ΔIDF make for an excellent comparison. First, these product specific baselines are not straw men; they have been shown to outperform Support Vector Machines on this dataset. Second, models built with the domain specific ΔIDF and models built the domain-independent class-bias score 322 both use the same classification function so that any differences between the two are based solely upon the quality of the models produced by the two training algorithms. Third, by evaluating the domain-independent class-bias score 322 against the topic area specific ΔIDF algorithm used to create its constituent sub-models, we negate any potential objections that our improvement was due to the difference between the baseline algorithm and the algorithm used to create the sub-models.

The model we show in FIG. 6 is a true domain independent model because it remains equally accurate across all domains. Unlike the domain dependent baselines, our domain independent model based on the domain-independent class-bias score 322 is just about as accurate on every domain. The size of one standard deviation for our model's accuracy over these 20 domains is a very small 1.69 percentage points as opposed to the in-domain model's 7.46 percentage points. The domain independent models built with the domain-independent class-bias score 322 are simple and over 4 times more reliable than building a domain specific model. The improvement of 4 times is seen from the y-axis shown in FIG. 6 and the y-axis represents accuracy and the value of “1” means 100% accurate. The 4 times improvement is based on the size of the standard deviation. The variance from the mean accuracy measures the unreliability. Using the domain-independent class-bias score 322 we can reasonably estimate how accurate our model will be on a new domain without testing it on that domain.

It has been discovered that the computing system 100 provides domain independent models based on the domain-independent class-bias score 322 are vastly preferable to domain specific models because they are much easier and less costly to create and maintain. Furthermore, our domain independent models are even more accurate than domain specific models due to their ability to leverage more data (including the data with the conflicting orientation 408 of FIG. 4, the unknown orientation 406 of FIG. 4, and the neutral orientation 410 of FIG. 4) and eliminate noisy features, since our domain-independent models are over 4 times more reliable than domain specific models. Considering the fact that the domain independent models based on the domain-independent class-bias score 322 require no changes to work well on a new topic area and are the best choice to use for sentiment analysis on a new topic area.

It has been also discovered that the computing system 100 provides general purpose model based on the domain-independent class-bias score 322 outperforms domain-specific models. There are at least two reasons for this performance improvement.

First, general purpose models built with the domain-independent class-bias score 322 outperform more specialized models by leveraging large amounts of data that imperfectly fits the special circumstances defined by the topic of interest. By trading a little bit of quality for a large amount of quantity these general purpose models are exposed to both a greater number of similar expressions and a greater variety of expressions. The increased volume of data for similar expressions helps to sharpen our accuracy for those expressions while the greater variety of expressions allows us to understand new content that would be otherwise meaningless.

To prove this point we restricted general purpose models built with the domain-independent class-bias score 322 to the total amount of data points in the target domain. This artificial handicap reduced the accuracy of the general purpose models built with the domain-independent class-bias score 322 to 74.23%. This is less accurate than the in-domain model to the 99.5% confidence interval. This exercise supports that the general purpose models built with the domain-independent class-bias score 322 works better in part because it leverages large amounts of out of domain data. The nearly 40 percentage point gain for the “Tools” product category, with only 19 labeled data points, is a clear example of why this approach is so important. Domain adaptation techniques were first created because there was not enough labeled data to build an accurate in-domain classifier. Thus accuracy on domains that already have a lot of data is less important than improving accuracy on domains with very little data.

Second, the general purpose models built with the domain-independent class-bias score 322 intelligently uses the division between different topic areas to improve accuracy. We offer a proof by contradiction that the improvements from the general purpose models built with the domain-independent class-bias score 322 are not solely due to greater data volume. If the general purpose models built with the domain-independent class-bias score 322 only worked because it uses more data, then training on the union of the source product categories should work as well as the general purpose models built with the domain-independent class-bias score 322. This is not the case. We built a model using the domain-independent class-bias score 322 on the books, DVDs, and electronics product review domains. We also built a domain specific model using ΔIDF on the union of the data from the books, DVDs, and electronics product review categories. Both models were built using the same data and both models were used the same classification function to produce judgments. However, the model built with the domain-independent class-bias score 322 is on average 88.4% accurate on the remaining test domains, while the union model was 84.2% accurate. This is a clear contradiction. Thus, using proof by contradiction we can conclude that the performance of the general purpose models built with the domain-independent class-bias score 322 cannot be solely explained by an increase in training data.

The only explanation for why the general purpose models built with the domain-independent class-bias score 322 does better than the union model is that the general purpose models built with the domain-independent class-bias score 322 uses the information provided by dividing the dataset into topics to produce a better model. The general purpose models built with the domain-independent class-bias score 322 uses this information to verify feature quality and refine feature scores.

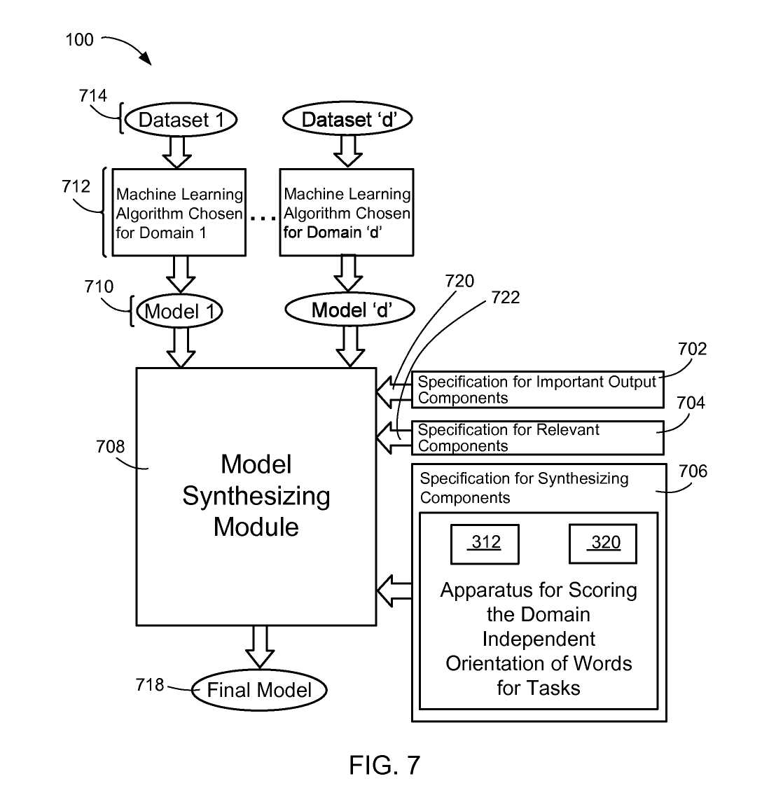

Referring now to FIG. 7, therein is shown an architecture view of an exemplary application for a model synthesis with the computing system 100. The computing system 100 can include an importance specification module 702, a relevance specification module 704, a synthesis specification module 706, and a model synthesis module 708. The computing system 100 can also include domain-specific models 710 generated by domain-specific modules 712 based on domain-specific data 714.

As an example, FIG. 7 provides an architecture on how to build a domain-independent model 718 to learn a general purpose sentiment strength and orientation model of the features 302 of FIG. 3, such as words and phrases, including those with the conflicting orientation 408 of FIG. 4 in different topic areas or across the multiple domains 304, those with the neutral orientation 410 of FIG. 4 in one or more topic areas, and those with the unknown orientation 406 of FIG. 4 in one or more topic areas. FIG. 7 shows how the transformations 314 of FIG. 3 and the domain-independent class-bias score 322 of FIG. 3 from the synthesis specification module 706 interacts with the model synthesis module 708.

In the example in FIG. 7, the architecture uses a set of the domain-specific models 710, such as sentiment models, built on the domain-specific data 714 for the different domains, or topic areas, as inputs to the model synthesis module 708 because sentiment orientations from the multiple domains 304 can be used to measure domain independence with the architecture. For this example, ΔIDF is used to build the domain-specific models 710, but other similar algorithms such as logistic regression could be selected instead.

In this architecture example, the importance specification module 702, a relevance specification module 704, a synthesis specification module 706 also provide inputs to the model synthesis module 708. The importance specification module 702 identifies the important components for a domain-independent model 718 generated from the model synthesis module 708. The relevance specification module 704 identifies relevant components 722 used by the model synthesis module 708 to build the output components for the domain-independent model 718. The synthesis specification module 706 specifies how to synthesize the domain-independent model 718 in the model synthesis module 708 by identifying the output components for the domain-independent model 718 from the relevant components 722 from the relevance specification module 704.

As a further exemplary description of the importance specification module 702, this module produces a list of important model components 720 that the domain-independent model 718 from the model synthesis module 708 should include. Examples of the important model components 720 can include key value pairs, where the features 302 of FIG. 3 as words or phrases as the key and orientation scores or the class bias scores 306 of FIG. 3 as the value. The important model components 720 have a domain-independent orientation or as a more specific example a domain-independent sentiment orientation.

The importance specification module 702 can gather any component seen in one of the domain-specific models 710 as the sources models to be used as a list of unique candidates. Duplicates are not allowed. This can be implemented with a hashtable lookup by looping through every component in every instance of the domain-specific models 710. If the component is not in the hashtable, then put it in the hashtable.

The importance specification module 702 can continue by removing from the list of candidates any component which is unlikely to occur often enough to be useful. This can be implemented by comparing the number of the domain-specific models 710 this component occurs in with this statistic for all the other components using statistical confidence testing. If the term occurs in more of the domain-specific models 710 than average and if the statistical confidence test passes a certain threshold then the component should not be removed. Otherwise, the component should be removed from the list of candidates.

The importance specification module 702 can progress by removing from the list of candidates any component with a value who's sign is too close to being randomly distributed in the domain-specific models 710 where it occurs. A way to implement this is to first count the number of domain-specific models 710 where this component's value has a positive signs and the number of the domain-specific models 710 where this component's value has a negative sign. The importance specification module 702 can compare these two numbers with this statistic for all the other components that occurred in the same total number of the domain-specific models 710 using statistical confidence testing. If the statistical confidence test passes a certain threshold then the component should not be removed. Otherwise, the component should be removed from the list of candidates.

The importance specification module 702 can return the list of candidates for the important model components 720. The important model components 720 can be inputs to the model synthesis module 708.

As a further exemplary description of the relevance specification module 704, this module identifies relevant components 722 and takes as input a set of the models, such as the domain-specific models 710, and a value that specifies the current component, such as the important model components 720, that the algorithm is working on creating. This mechanism returns the current component found in every model or in the domain-specific models 710. Since our components are key value pairs and the domain-specific models 710 are hashtables, the relevance specification module 704 can use the key function of the hashtable data structure to find the current component in each of the domain-specific models 710 or the different domain models.

As a further exemplary description of the synthesis specification module 706, this module for a classification task generates the domain-independent class-bias score 322 of FIG. 3 or a domain independent sentiment orientation score that can discriminate between the positive sentiment and negative sentiment categories. The synthesis specification module 706 can discriminate by dividing the ΔIDF scores for each domain from the multiple domains 304 into a set of positive and negative scores. Scores with a zero can be ignored.

The synthesis specification module 706 can operate on the positive set of scores to calculate the orientation to the positive sentiment category or the positive orientation 402 of FIG. 4. This is called “P” score.

3 The synthesis specification module 706 can operate on the negative set of scores to calculate the orientation to the negative sentiment category or the negative orientation 404 of FIG. 4. This is called “N” score.

The synthesis specification module 706 can subtract the absolute value of the “N” score from the “P” score resulting in the domain-independent class-bias score 322. The formula for this is shown in Equation 9.

For illustrative purposes, the synthesis specification module 706 is described implementing the domain-independent class-bias score 322 with using both the positive orientation 402 and the negative orientation 404 as expressed in Equation 9, although it is understood that the synthesis specification module 706 can calculate the domain-independent class-bias score 322 in different ways. For example, the synthesis specification module 706 can calculate the domain-independent class-bias score 322 with only the negative orientation 404 or with only the positive orientation 402 as expressed in Equation 4 and in Equation 8, respectively.

The model synthesis module 708 generates and returns the final model component and the domain-independent model 718 that it has been instructed based on the important model components 720, the relevant components 722, the domain-independent class-bias score 322, or a combination thereof.

The modules described in this application can be part of the first software 226 of FIG. 2, the second software 242 of FIG. 2, or a combination thereof. These modules can also be stored in the first storage unit 214 of FIG. 2, the second storage unit 246 of FIG. 2, or a combination thereof. The first control unit 212, the second control unit 234, or a combination thereof can execute these modules for operating the computing system 100.

The computing system 100 has been described with module functions or order as an example. The computing system 100 can partition the modules differently or order the modules differently. For example, the synthesis specification module 706 can include the transformation module 312 and the consolidation module 320 as separate modules although these modules can be combined into one. Also, the transformation module 312 can be split into separate modules for implementing in the separate modules Equations 1-3 and Equations 5-7. Similarly the consolidation module 320 can be split into separate modules for each module implement Equation 4, Equation 8, or Equation 9.

The modules described in this application can be hardware implementation, hardware circuitry, or hardware accelerators in the first control unit 212 of FIG. 2 or in the second control unit 234 of FIG. 2. The modules can also be hardware implementation, hardware circuitry, or hardware accelerators within the first device 102 or the second device 106 but outside of the first control unit 212 or the second control unit 234, respectively.

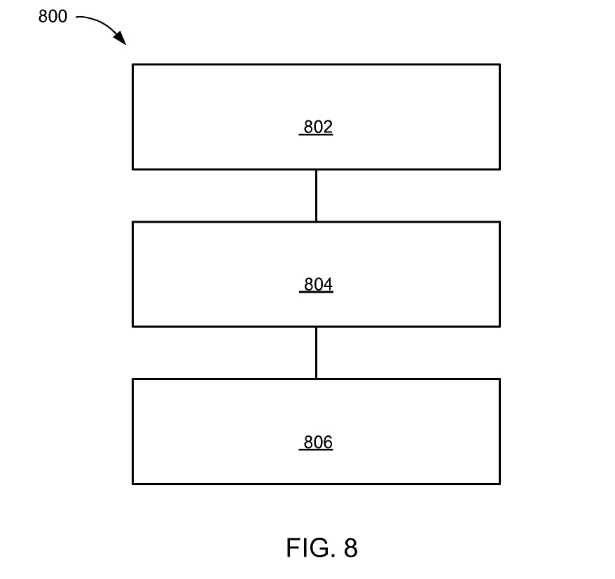

Referring now to FIG. 8, therein is shown a flow chart of a method 800 of operation of a computing system 100 in a further embodiment of the present invention. The method 800 includes: gathering a distribution of a class bias score for a feature and across multiple domains through a communication unit in a block 802; generating a transformation for a characteristic of domain independence based on the class bias score in a block 804; and computing a domain-independent class-bias score based on the transformation in a block 806.

It has been discovered that the computing system 100 can be applied to out of the box new topics and domains without additional training because the transformations and the domain-independent class-bias score is shown above to be accurate despite limited training. The utilization of additional information from the conflicting orientation, the unknown orientation, or the neutral orientation in addition to the positive orientation and the negative orientation across multiple domains provide a wider vocabulary for the features, such as words or phrases. The wider vocabulary provides more accurate scores for the vocabulary.

It has be further discovered the that domain-independent class-bias score can be used to generate domain-independent models that out performs domain-specific models as well as other general domain adaption models. This allows for improved recommender systems with more accurate orientation or sentiment models. This also allows for more opinion expressions and more diverse opinion expressions when doing sentiment and opinion mining. This further improves electronic personal assistants with more accurate sentiment information. This yet further increases the accuracy of data analytics and business intelligence that uses sentiment analysis technology.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A computing system comprising:
a gather module configured to gather a distribution of a class bias score for a feature and across multiple domains;
a transformation module, coupled to the gather module, configured to generate a transformation for a characteristic of a domain independence based on the class bias score; and
a consolidation module, coupled to the transformation module, configured to compute a domain-independent class-bias score based on the transformation.

2. The system as claimed in claim 1 wherein the consolidation module is configured to compute the domain-independent class-bias score based on the class bias score, which has conflicting orientation, a neutral orientation, an unknown orientation, or a combination thereof, across the multiple domains.

3. The system as claimed in claim 1 wherein the transformation module is configured to apply a weighting scheme for the class bias score.

4. The system as claimed in claim 1 wherein:
the transformation module is configured to generate transformations with one for each characteristics of the domain independence based on the class bias score; and
the consolidation module is configured to combine the transformations for the characteristics.

5. The system as claimed in claim 1 wherein the transformation module is configured to select the class bias score having a positive orientation.

6. The system as claimed in claim 1 wherein the transformation module is configured to select the class bias score having a negative orientation.

7. The system as claimed in claim 1 wherein the transformation module is configured to generate a popularity score, a reliability score, a strength score, or a combination thereof for the characteristic.

8. The system as claimed in claim 1 wherein:
the transformation module is configured to:
select the class bias score having a positive orientation,
select the class bias score having a negative orientation,
generate transformations based the positive orientation and the negative orientation;
the consolidation module is configured to combine the transformations for the positive orientation and the negative orientation.

9. The system as claimed in claim 1 wherein:
the transformation module is configured to generate a popularity score, a reliability score, and a strength score, for the characteristic; and
the consolidation module is configured to multiply the popularity score, the reliability score, and the strength score.

10. The system as claimed in claim 1 further comprising a model synthesis module, coupled to the consolidation module, configured to generate a domain-independent model based on the domain-independent class-bias score.

11. A method of operation of a computing system comprising:
gathering a distribution of a class bias score for a feature and across multiple domains through a communication unit;
generating a transformation for a characteristic of a domain independence based on the class bias score; and
computing a domain-independent class-bias score based on the transformation.

12. The method as claimed in claim 11 wherein computing the domain-independent class-bias score includes computing the domain-independent class-bias score based on the class bias score, which has conflicting orientation, a neutral orientation, an unknown orientation, or a combination thereof, across the multiple domains.

13. The method as claimed in claim 11 wherein generating the transformation includes applying a weighting scheme for the class bias score.

14. The method as claimed in claim 11 wherein:
generating the transformation for the characteristic includes generating transformations with one for each characteristics of the domain independence based on the class bias score; and
computing the domain-independent class-bias score based on the transformation includes combining the transformations for the characteristics.

15. The method as claimed in claim 11 wherein generating the transformation based on the class bias score includes selecting the class bias score having a positive orientation.

16. The method as claimed in claim 11 wherein generating the transformation based on the class bias score includes selecting the class bias score having a negative orientation.

17. The method as claimed in claim 11 wherein generating the transformation for the characteristic includes generating a popularity score, a reliability score, a strength score, or a combination thereof for the characteristic.

18. The method as claimed in claim 11 wherein:
generating the transformation for the characteristic of domain independence based on the class bias score includes:
selecting the class bias score having a positive orientation,
selecting the class bias score having a negative orientation,
generating transformations based the positive orientation and the negative orientation;
computing the domain-independent class-bias score based on the transformation includes combining the transformations for the positive orientation and the negative orientation.

19. The method as claimed in claim 11 wherein:
generating the transformation for the characteristic includes generating a popularity score, a reliability score, and a strength score, for the characteristic; and
computing the domain-independent class-bias score based on the transformation includes multiplying the popularity score, the reliability score, and the strength score.

20. The method as claimed in claim 11 further comprising generating a domain-independent model based on the domain-independent class-bias score.
